(19) United States
(12) Patent Application Publication
(10) Pub. No.: US 2026/0309272 A1
(43) Pub. Date: Oct. 8, 2026

(54) CRYOGENIC TANK AND METHOD FOR MANUFACTURING SAME

(71) Applicant: CRYOLOR, Argancy (FR)

(72) Inventor: Lucien VARRASSI, Porcelette (FR)

(21) Appl. No.: 19/482,283

(22) PCT Filed: Apr. 24, 2024
(86) PCT No.: PCT/EP2024/061166

§ 371 Date: Nov. 7, 2025

(30) Foreign Application Priority Data
May 22, 2023 (FR) FR2305013

(51) Int. Cl. F17C 1/00

(52) U.S. Cl. CPC F17C 1/00; F17C 2203/0643; F17C 2209/2181; F17C 2209/221; F17C 2209/232; F17C 2221/014; F17C 2223/0161; F17C 2260/011

(57) ABSTRACT

A cryogenic vessel and to a method for manufacturing same, configured to store a liquefied gas at a cryogenic temperature preferably below −100 °C, for example liquid nitrogen, the vessel including of a set of welded sheet(s) of 201LN austenitic stainless steel. Wherein the vessel is work hardened to a degree of work hardening of between 1% and 12%, and preferably between 5% and 10%, i.e. the set of welded sheet(s) of 201LN austenitic stainless steel is work hardened to a degree of work hardening of between 1% and 12% and preferably between 5% and 10%.

### CROSS REFERENCE TO RELATED APPLICATIONS

This application is a 371 of International Application No. PCT/EP2024/061166, filed Apr. 24, 2024, which claims priority to French Patent Application No. FR 2305013, filed May 22, 2023, the entire contents of which are incorporated herein by reference.

### BACKGROUND

The invention relates to a cryogenic vessel and to a method for manufacturing same.

The invention relates more particularly to a cryogenic vessel configured to store a liquefied gas at a cryogenic temperature preferably below −100 °C, for example liquid nitrogen, the vessel consisting of a set of welded sheet(s) of 201LN austenitic stainless steel.

The invention relates to fixed or movable vessels for storing or transporting cryogenic liquids (air gases, CO2, LNG, nitrogen, ethylene, hydrogen or helium for example).

It is known practice to improve the mechanical characteristics of steels by work hardening, i.e. by deformation beyond the plastic limit of the material. This work hardening is defined by standards (cf. for example “EN 13458-2”).

Generally speaking, the sealed vessel is filled with water and is pressurized and “inflated” in predefined cycles until stresses greater than the elastic limit of the metal are induced, to enhance the mechanical characteristics.

To date, regulations permit only a limited number of alloys for the transport and storage of cryogenic fluids such as hydrogen (six to date). For instance, it is known practice to manufacture and use vessels made of a 304N or 304LN alloy.

It is desirable to be able to use other materials which are less expensive and more lightweight or which make it possible to provide vessels with improved performance qualities.

This is not easy because the vessel must have good mechanical strength at low temperature and good resilience and must not be subject to cracks, in particular in the welds or at the edge of the welds.

### SUMMARY

One aim of the present invention is to overcome all or some of the abovementioned drawbacks of the prior art.

To that end, the vessel according to the invention, which in all other respects is in accordance with the generic definition thereof in the preamble above, is essentially characterized in that the vessel is work hardened to a degree of work hardening of between 1% and 12% and preferably between 5% and 10%, i.e. the set of welded sheet(s) of 201LN austenitic stainless steel is work hardened to a degree of work hardening of between 1% and 12% and preferably between 5% and 10%.

Moreover, embodiments of the invention may have one or more of the following features:
the vessel is work hardened to a degree of work hardening of between 5% and 7%, for example 6%,
the set of sheet(s) is work hardened in the leaktight assembled configuration of the vessel by internally pressurizing the vessel with an incompressible fluid, for example water,
the set of sheet(s) is work hardened before assembly and welding, for example during a rolling operation,
the vessel consists of sheet(s) of 201LN austenitic stainless steel welded via a “butt” weld with a pair of wires and a flux designed for 201LN steel.

The invention also relates to a method for manufacturing a cryogenic vessel configured to store a liquefied gas at a cryogenic temperature preferably below −100 °C, for example liquid nitrogen, the method comprising a step of assembling and welding a set of sheets of 201LN austenitic stainless steel by welding, a step of work hardening the sheets, the work-hardening step being carried out before the assembly and welding step and/or after assembly and welding, the work-hardening step being configured to cause a deformation beyond the plastic range of the 201LN steel, the degree of work hardening being between 1% and 12% and preferably between 5% and 10%.

According to other possible specific features, the degree of work hardening is between 5% and 7%, for example 6%.

The invention may also relate to any alternative device or method comprising any combination of the features above or below within the scope of the claims.

Other particular features and advantages will become apparent upon reading the following description, which is provided with reference to the figures.

### BRIEF DESCRIPTION OF THE FIGURES

The invention will be better understood upon reading the following description, which is given solely by way of example and with reference to the appended drawings, in which:

FIG. 1 is a schematic and partial view in longitudinal section of one example of a vessel during work hardening,

FIG. 2 is a schematic representation of the breaking strength values of parts made of austenitic stainless steel making up the vessel according to the invention that were subjected to testing, for respectively four levels of work hardening,

FIG. 3 is a schematic representation of the values for resistance to an impact test of parts made of crude austenitic stainless steel making up the vessel, at the weld and at the edge of the weld, for respectively four levels of work hardening,

FIG. 4 is a schematic representation of the values for resistance to an elastic limit test of parts made of crude austenitic stainless steel making up the vessel, at the weld and at the edge of the weld, for respectively three levels of work hardening.

### DETAILED DESCRIPTION OF THE PREFERRED EMBODIMENTS

Throughout the figures, the same reference signs relate to the same elements.

In this detailed description, the following embodiments are examples. Although the description refers to one or more embodiments, this does not mean that the features apply only to a single embodiment. Individual features of different embodiments can also be combined and/or interchanged in order to provide other embodiments.

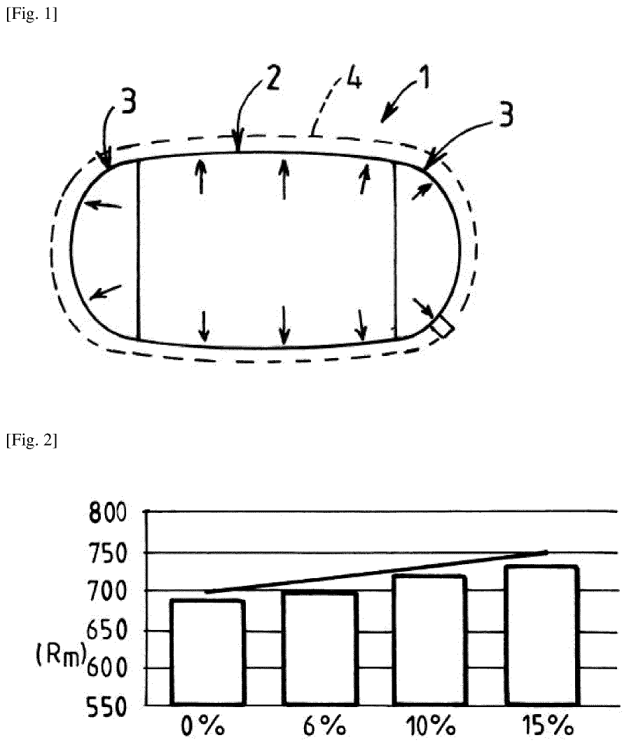

FIG. 1 very schematically illustrates a cryogenic vessel 1 configured to store a liquefied gas at a cryogenic temperature (preferably below −100 °C), for example liquid nitrogen.

The vessel 1 consists of a set of welded sheets of 201LN austenitic stainless steel.

The composition of the 201LN steel includes in particular a content (in moles) of 7% to 19% of chromium and 3% to 9% of nickel. It also contains traces of manganese, phosphorus, sulfur and nitrogen. It has a relatively low carbon content, which makes it very resistant to corrosion.

This alloy has the advantage of a relatively low nickel content, which makes it less expensive.

For example, the steel may have the following composition in molar percentage: Cr 16% to 18.5%, Mn 6.40% to 7.50%, Ni 4% to 5%, Cu less than 1%, Si≤0.75%, N 0.10% to 0.25%, P≤0.045%, C≤0.030%, S≤0.030% and the remainder iron.

For example, a sheet 2 forms a central cylindrical tube or shell closed at its ends by domes 3. The vessel 1 may thus have a cylindrical overall shape.

The set of steel sheets making up the vessel 1 is work hardened to a degree of work hardening of between 1% and 12% and preferably between 5% and 10%, i.e. the set of welded sheet(s) of 201LN austenitic stainless steel is work hardened to a degree of work hardening of between 1% and 12% and preferably between 5% and 10%, for example between 5% and 7%, for example 6%.

The degree or level of work hardening represents the reduction in relative dimension (thickness, for example) obtained by the deformation (pressurization and/or rolling, for example). This reduction in cross section may be expressed relative to the initial dimension (before work hardening), for example.

The work hardening is preferably obtained by cold stretching.

The work hardening may be carried out conventionally by internally pressurizing the vessel 1 with an incompressible fluid, for example water (as indicated schematically by arrows in FIG. 1). That is to say, the assembled/welded vessel 1 is subjected to one or more specific cycles of pressurization/deformation by injection into its closed and sealed internal volume (cf. for example the standard EN 13458-2).

Of course, as an alternative or in combination, the set of sheets making up the vessel 1 may be work hardened before assembly and welding, for example during the operations of rolling the sheets.

The inventor has found that the use of this specific 201LN alloy combined with the aforementioned degree of work hardening makes it possible to give the vessel all of the strength characteristics, in particular cold-resistance characteristics, necessary for the storage and transport of cryogenic fluids. In particular, and as explained below, the invention even makes it possible to give the vessel 1 a better mechanical-strength performance than the currently used vessels while at the same time reducing its cost.

FIG. 2 illustrates the tensile strength values (Rm in N/mm²) measured on samples (test coupons) work hardened respectively at 0%, 6%, 10% and 15% (from left to right) according to the standard EN ISO 4136. It will be noted that the tensile strength of the sample made of 201LN does not stop increasing with the degree of work-hardening. These values are similar to or greater than the results obtained for the material 304LN, which is known in particular in terms of resilience (cf. for example the standards EN 10028-7, EN 13458-2 annex C, and EN ISO 9016/EN ISO 148-1).

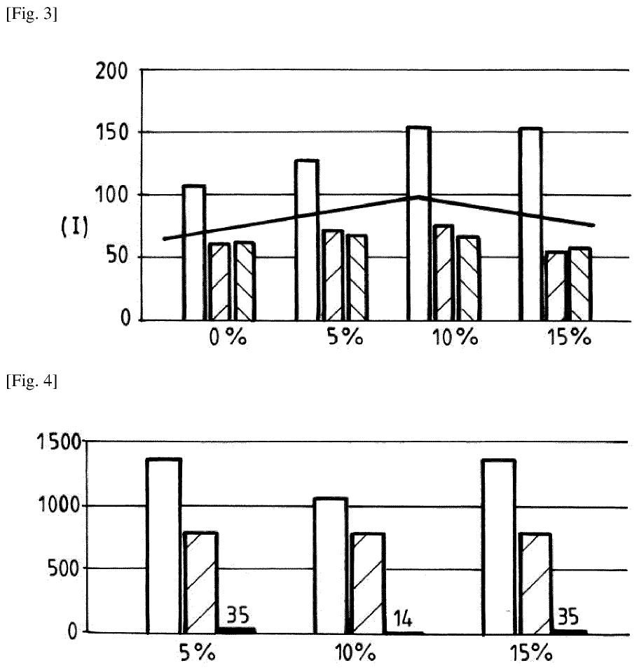

FIG. 3 illustrates the resilience limit values (impact test “I” J/cm² according to the EN 13458-2 standard) measured on welded samples (test coupons) work hardened respectively at 0%, 6%, 10% and 15% (from left to right). For each degree of work hardening, the three columns represent, respectively from left to right, the values for i) an impact test at −196 °C for the 201LN base material, ii) an impact test at −196 °C for a sample of two portions of 201LN welded at the weld, and iii) an impact test at −196 °C for a sample of two portions of 201LN welded at the “HAZ”.

“HAZ” denotes the join between the weld and the part made of 201LN. It is the heat-affected zone surrounding the weld in which the temperature of the welding process, combined with the irregular heating and cooling stresses, changes the alloy heat treatment properties.

It will be noted that the results obtained are greater than 50 J/cm2, which is envisaged by the standard ISO 21009. The strength decreases beyond a work hardening of 10%, in particular at the weld.

FIG. 4 illustrates the values of the elastic limit and breaking under tension on welded samples (test coupons) work hardened respectively at 6%, 10% and 15% (according to the standard EN 13458-2 and EN ISO 9016/EN ISO 148-1).

For each degree of work hardening, the three columns represent respectively from left to right: i) the tensile strength pressure level (Rm in MPa), ii) the elastic limit pressure value at 0.2% (in MPa), iii) the elongation limit in percent.

These various tests illustrate that, from 0% to 15% work hardening, the mechanical characteristics of the 201LN material in the base metal and the welding are enhanced by the degree of work hardening. However, between 10% and 15% work hardening, the value of the resilience in the weld (in the metal deposited by the weld and in the “HAZ” heat-affected zone) decreases significantly.

Thus, this alloy and the degrees of work hardening of 1% to 12% have advantages but are optimal between 6% and 10%, and preferably around 6%, work hardening.

As depicted schematically in dotted lines in FIG. 1, the vessel 1 may comprise an outer jacket 4 around the wall consisting of the work-hardened 201LN material such that a double-wall vessel with thermal insulation (for example under vacuum) is formed between the two jackets.

The work-hardened material according to the invention allows plastic deformation without breaking and has satisfactory ductility. It is capable of being welded. This structure allows the vessel to withstand the propagation of cracks.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-7. (canceled)

8. A cryogenic vessel configured to store a liquefied gas at a cryogenic temperature, the vessel comprising a set of welded sheet(s) of 201LN austenitic stainless steel, wherein the assembly of welded sheet(s) of 201LN austenitic stainless steel is work hardened to a degree of work hardening of between 5% and 10%.

9. The vessel as claimed in claim 8, wherein the assembly of welded sheets are work hardened to a degree of work hardening of between 5% and 7%.

10. The vessel as claimed in claim 9, wherein the assembly of welded sheets are work hardened to a degree of work hardening of 6%.

11. The vessel as claimed in claim 8, wherein the assembly of welded sheet(s) is work hardened in the leaktight assembled configuration of the vessel by internally pressurizing the vessel with an incompressible fluid.

12. The vessel as claimed in claim 11, wherein the incompressible fluid is water.

13. The vessel as claimed in claim 8, wherein the assembly of welded sheet(s) is work hardened before assembly and welding.

14. The vessel as claimed in claim 13, wherein the assembly of welded sheet(s) is work hardened during a rolling operation.

15. The vessel as claimed in claim 8, wherein the sheet(s) of 201LN austenitic stainless steel are welded via a “butt” weld with a pair of wires and a flux designed for 201LN steel.

16. A method for manufacturing a cryogenic vessel configured to store a liquefied gas at a cryogenic temperature, the method comprising:
assembling and welding a set of sheets of 201LN austenitic stainless steel by welding,
work hardening the set of sheets,
the work-hardening step being carried out before the assembly and welding step and/or after assembly and welding,
the work-hardening step being configured to cause a deformation beyond the plastic range of the 201LN steel, and
the degree of work hardening being between 5% and 10%.

17. The method of claim 16, wherein the cryogenic temperature is below −100 °C.

18. The method of claim 16, wherein the liquefied gas is liquid nitrogen.

19. The method as claimed in claim 16, wherein the degree of work hardening is between 5% and 7%.

20. The method as claimed in claim 19, wherein the degree of work hardening is 6%.
